(19) United States
(12) Patent Application Publication
(10) Pub. No.: US 2006/0102601 A1
(43) Pub. Date: May 18, 2006

(54) Feedback controlled laser machining system

(75) Inventors: Michael Shirk, Brentwood, CA (US); Jevan Furmanski, Albany, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/271,454

(22) Filed: Nov. 10, 2005

Related U.S. Application Data
(60) Provisional application No. 60/627,634, filed on Nov. 12, 2004.

(51) Int. Cl. B23K 26/38; B23K 26/03

(52) U.S. Cl. 219/121.68; 219/121.83

(57) ABSTRACT

A system for machining a workpiece to desired finished workpiece specifications. The system comprises a system for producing a laser beam; a system for positioning the workpiece relative to the laser beam; a system for measuring the topography of the work piece and producing workpiece topography data; and a computer and control system operatively connected to the system for producing a laser beam, to the system for positioning the workpiece relative to the laser beam, and to the system for measuring the topography of the work piece and producing workpiece topography data. The computer and control system compares the workpiece topography data with the desired finished workpiece specifications and controls the system for positioning the workpiece relative to the laser beam so that the workpiece is moved with respect to the laser beam in a desirable fashion, within certain velocity, acceleration, and distance constraints. The computer and control system controls the system for producing a laser beam so that the laser beam machines the workpiece to the desired finished workpiece specifications.

### CROSS-REFERENCE TO RELATED APPLICATIONS

This application claims the benefit of U.S. Provisional Patent Application No. 60/627,634 filed Nov. 12, 2004 by Michael Shirk and Jevan Furmanski, titled “Laser Power Feedback Control by Logical Active Optical Gating or Feedback Controlled Laser Milling Machine CAM System.” U.S. Provisional Patent Application No. 60/627,634 filed Nov. 12, 2004 titled “Laser Power Feedback Control by Logical Active Optical Gating or Feedback Controlled Laser Milling Machine CAM System” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to laser machining and more particularly to a laser machining system.

2. State of Technology

U.S. Pat. No. 6,627,844 issued Sep. 30, 2003 to Xinbing Liu and Chen-Hsiung Cheng and assigned to Matsushita Electric Industrial Co., Ltd, for a method of laser milling, provides the following state of technology information, “Material ablation by pulsed light sources has been studied since the invention of the laser. Reports in 1982 of polymers having been etched by ultraviolet (UV) excimer laser radiation stimulated widespread investigations of the process for micromachining. Since then, scientific and industrial research in this field has proliferated—mostly spurred by the remarkably small features that can be drilled, milled, and replicated through the use of lasers.”

U.S. Pat. No. 6,610,961 issued Aug. 26, 2003 to Chen-Hsiung Cheng and assigned to Matsushita Electric Industrial Co., Ltd, for a system and method of workpiece alignment in a laser milling system, describes one example of state of technology information as, “a method is provided for aligning a workpiece in a laser drilling system. The method includes: determining position data for two or more target alignment markers residing on a movable workpiece holder, where the target alignment markers are defined in relation a drilling pattern for the workpiece and indicate a target workpiece position; placing a workpiece on the movable workpiece holder; measuring position data for alignment markers associated with the workpiece, thereby determining an actual workpiece position; and computing a translation angle between the actual workpiece position and the target workpiece position simultaneously with computing a translation distance between the actual workpiece position and the target workpiece position.”

### SUMMARY

The three dimensional sculpting of very hard materials, such as alumina, has been problematic in the past since diamond tools wear significantly during any machining processes, leading to dishing and other irregularities that result from the tool-wear. Some methods have been adapted to try to compensate for the tool wear, that increase the protrusion of the diamond tool as it is expected to wear. This is only partially effective, as not only are the tools shortened in length, but they are also dulled by use.

Applicants sought a system that uses a tool that doesn't wear, and has been shown previously to achieve excellent precision in material removal. This is a laser, or in this specific cases an ultrashort pulsed laser. Lasers have a different problem. Their main problem is that they are not well defined spatially the way a mechanical tool is. To perform precision mechanical machining, the precision comes by precisely controlling the location of the tool with respect to the workpiece. If they do not touch with significant force, then no material is removed. With a laser, this intrinsic feedback is not present. The present invention is used to overcome that, and to develop a system that gets its feedback using an optical device, either a laser profilometer or an interferometric profilometer. This data is then used to create a control scheme that precisely controls both laser output and part position synchronously.

The present invention utilizes a combination of an ultrashort pulsed laser, computer control part and beam positioning, and precise control of electro-optic components to machine materials to a desired shape with great accuracy and precision. The present invention has uses for real-time control of laser power for machining/shaping operations, for micromachining/microsculpting of dielectrics and metals for optics and research, for writing of complicated micro-channels in very hard materials, for fluidic research, for micromachined markings and tracking codes in parts, and for other laser machining operations.

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for machining a workpiece to desired finished workpiece specifications. The system comprises machining a workpiece to desired finished workpiece specifications. A laser is used to produce a laser beam. The workpiece is positioned relative to the laser beam. A profilometer is used to measure the topography of the workpiece and produce workpiece topography data. The workpiece topography data is compared with the desired finished workpiece specifications producing comparison data. The data is used for controlling the positioning of the workpiece relative to the laser beam using the comparison data to cause the work piece to be moved with respect to the laser beam in a desirable fashion, within certain velocity, acceleration, and distance constraints, and controlling the laser using the comparison data to cause the laser beam to machine the workpiece to the desired finished workpiece specifications. In one embodiment an apparatus for machining a workpiece to desired finished workpiece specifications comprises a laser that produces a laser beam; a controlled stage that positions the workpiece relative to the laser beam, wherein the workpiece is operatively connected to the controlled stage; a profilometer that measures the topography of the work piece and produces workpiece topography data; and a computer and control system operatively connected to the laser, to the controlled stage, and to the profilometer, wherein the computer and control system compares the workpiece topography data with the desired finished workpiece specifications and controls the controlled stage and the laser; wherein the computer and control system causes the workpiece to be moved with respect to the laser beam in a desired fashion, within certain velocity, acceleration, and distance constraints and wherein the computer and control system causes the laser to machine the workpiece to the desired finished workpiece specifications.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates one embodiment of a system of the present invention.

FIG. 2 illustrates another embodiment of the present invention.

FIG. 3 illustrates another embodiment of the present invention.

FIG. 4 illustrates another embodiment of the present invention.

FIG. 5 illustrates another embodiment of the present invention.

FIG. 6 illustrates another embodiment of the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

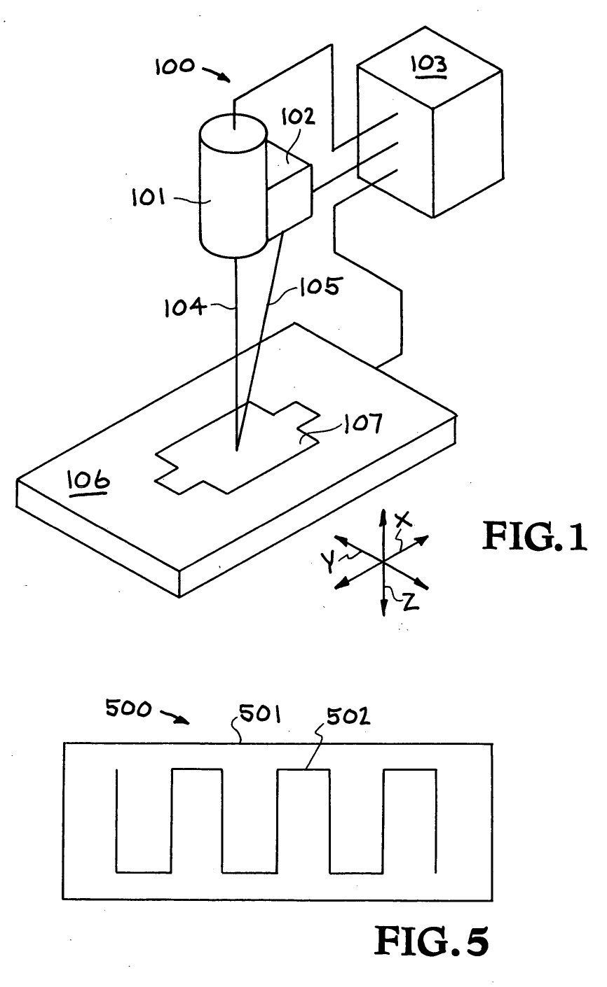

Referring now to the drawings, and in particular to FIG. 1, one embodiment of machining system constructed in accordance with the present invention is illustrated. The machining system is designated generally by the reference numeral 100. The machining system 100 processes a workpiece to desired finished workpiece specifications. The machining system 100 comprises a laser that produces a laser beam; a multi-axis motorized controlled stage operatively connected to the laser that positions the workpiece relative to the laser beam; a profilometer that measures the topography of the work piece and produces workpiece topography data; and a computer and control system operatively connected to the laser, to the multi-axis motorized controlled stage, and to the profilometer. The computer and control system compares the workpiece topography data with the desired finished workpiece specifications and controls the multi-axis motorized controlled stage and the laser. The computer and control system causes the work piece to be moved with respect to the laser beam in a desirable fashion, within certain velocity, acceleration, and distance constraints and controls the laser output so as to machine the workpiece to the desired finished workpiece specifications.

The laser machining machine system 100 uses a laser beam 104 for machining a workpiece 107. The laser machining system 100 includes a laser 101 that produces the laser beam 104. The workpiece 107 is positioned in the path of the laser 104 by a multi-axis motorized controlled stage 106 that provides movement of the workpiece 107 along an X axis, a Y axis, and a Z axis. A laser profilometer 102 is positioned adjacent the laser 102. The laser profilometer 102 utilizes a laser beam 105 to measures the topography of a workpiece 107. Instead of a laser profilometer 102, an interferometric profilometer can be used as the profilometer 102. Instead of an interferometric profilometer 102, a white light interferometric profilometer can be used as the profilometer 102.

Once the laser profilometer 102 measures the topography of the workpiece 107 the topography data is provided to a computer and control system 103. The computer and control system 103 compares the topography data of the workpiece 107 with desired specifications of the workpiece 107 that have been provided to the computer and control system 103. The desired specifications of the workpiece 107 are prepared from specifications and/or drawings of the desired finished work piece. The computer and control system 103 causes the workpiece 107 to be moved with respect to the laser beam 104 in a desirable fashion, within certain velocity, acceleration, and distance constraints. The computer and control system 103 controls the laser and workpiece to machine the workpiece to the desired finished specifications.

The present invention provides a laser machining which employs a feedback control system that allows the very accurate removal of material to arbitrary specifications. The workpiece 107 to be machined is held to the multi-axis motorized, controlled stage 106. The motor controller is in turn controlled by the Graphical User Interface (GUI) computer interface in the computer and control system 103. This causes the workpiece 107 to be moved with respect to the laser beam 104 in any desirable fashion, within certain velocity, acceleration, and distance constraints. Typically, the workpiece 107 is moved at constant velocity so as not to interfere with the laser power control of the machining process. The topography of the workpiece 107 is monitored by the laser profilometer 102, which is accurate to approximately 1 μm, and measures a spot ˜30 μm in diameter. It samples the surface at 1000 Hz, and this data is recorded by the computer and control system 103. This data is used to drive the feedback loop.

The user inputs into the computer some surface datum that is desired as the final product of the machining cycle. The surface is scanned by the optical surface measurement system, and an accurate topographic profile is generated and compared to this datum. The difference of these is considered “error,” and a control model determines the program required by the laser mill to eliminate this error through laser ablation.

The laser output is typically determined by the very accurate clock control of an optical gate, which is the last element of the laser amplification cavity, and thus is common to many laser systems. The laser must release each pulse at a very specific time interval, or the performance of the system degrades. The output must occur at specific times, and at these the output can be controlled in binary fashion, that is to either accept or reject each pulse as it becomes available. The gate must remain closed at other times to suppress unwanted laser emissions. In most lasers, the pulse is always transmitted to the part, as there is no logic employed. The present invention allows this to be precisely controlled so each pulse can be accepted or rejected individually and specifically. The present invention includes the control algorithm and mathematics required to describe the effects of superposition of laser pulses as the laser is scanned over the part. The present invention illustrates that the laser and motion system are controlled to achieve the desired surface profiles and surface finish. The results of preliminary testing showed that femtosecond pulsed-laser machining is suitably linear and predictable to warrant an automated approach to manufacturing.

The laser 101 laser is an ultrashort pulse laser. Ultrashort pulses are so short that laser energy is deposited on a timescale that is much less than the electron-lattice coupling time, and therefore ablated material is excited and removed so quickly that little heat can be transferred to the bulk. In addition, since the electric field intensity of the femtosecond light is so great, materials that are usually transparent (band-gap>photon energy) to near infrared light become absorbing due to processes such as multi-photon ionization and electron avalanche, further containing the laser energy. Finally, ultrashort pulses are very small in all 3 dimensions. For comparison value, a 1-ns pulse of light is physically 1-foot (30 cm) long, while a 100-fs pulse is 4 orders of magnitude shorter, or 30 mm long. This means that the interaction volume at a surface is extremely small and precise, and all interactions occur before any plasma expansion or significant surface alteration is possible. Shortly after the pulse is delivered, the electrons that have absorbed the energy transfer it to the lattice, and the material is locally heated causing rapid expansion whereby the heated material is removed and material only a few 100's of nm away is still cool. Typically, a few 10's to 100's of nanometers of material are removed per pulse. This property allows the creation of surfaces with very smooth and accurate surface profiles. In order to realize this potential accuracy, the physical material removal was very well characterized, and a control system was developed that meters the delivery of pulses to the target in a very precise, controlled manner. In one embodiment, the laser 101 is a 825-nm Ti:Sapphire femtosecond pulsed laser.

After the computer has evaluated the surface-datum error, the control action is generated. This control action translates to the fraction of pulses that will be allowed to hit and ablate each sector of the surface. A sector is some arbitrary area corresponding to a group of pulses to be fractionated. Currently, one pulse group, or “word” is comprised of four letters repeated identically, and each letter contains a control pulse which is eight laser pulses in temporal length. Thus, each letter contains 3-bit precision, and each word repeats this so as to smooth out the gaps in machining over the sector. For large errors, the system simply operates at 100% capacity for a given sector, and the error must be corrected in a later cycle when the error is less than the maximum depth machinable in one pass.

The control action is generated for the entire surface, and this information is broken up into individual parts corresponding to each pass in a raster scan. This results in a train of pulse-trains, and these are stored on an Arbitrary Waveform Generator (AWG) which is controlled by the computer. The AWG can generate the control signal in real-time, as the information is stored in independent memory on the card, and this can be accessed or triggered externally via a logical trigger input. The control signal is stored in such a way that the output of the laser is triggered by the position of the motion stages, which translates to synchronized machining with respect to the actual position of the sample, and not by some estimated time to arrive at the beginning of a pass of the raster.

As the sample reaches the position where the machining is to take place (there is a dead-zone on either side of the raster for acceleration of the sample to constant feedrate) the control signal is triggered by the motion stage. The control signal (pulse-train) is then played open-loop into a logical AND gate, which compares the standard clock pulse for the optical gate and the control effort. When both are “true,” the pulse is allowed to reach the workpiece. This addition to the timing of the laser must be calibrated, as the time for the information to make the round trip from the clock to the AND gate and back to the optical gate is enough for the pulse to have come and gone. The clock pulse must therefore be pre-dated, so the result will arrive at the correct time.

The control system currently uses four letter “words” of 3 bit “letters.” This system was chosen to reflect the maximum flexibility of machining over the largest allowable “sector.” If a sector is too big, then pixelation effects will become recognizable and the added precision is no longer useful. If the letters are not repeated, then the end of a sector is the only part of the sector eligible for control action. A random distribution of gaps in the control pulse would be ideal, but considerably more difficult to generate and, from observation, not necessary. Thus there is an inherent trade-off between the precision of each machining cycle and the resolution of the machined profile. This is improved by higher frequency switching (10 kHz laser is on the horizon). The precision of the optical measurement and any hysteresis in the motion system is also a consideration in this, as arbitrary precision in the laser control process can be obviated by sensor drift, inaccuracy, noise, etc. Consequently, all parts of the system must be improved in unison, as there are a number of limiting factors on the accuracy and precision of the system.

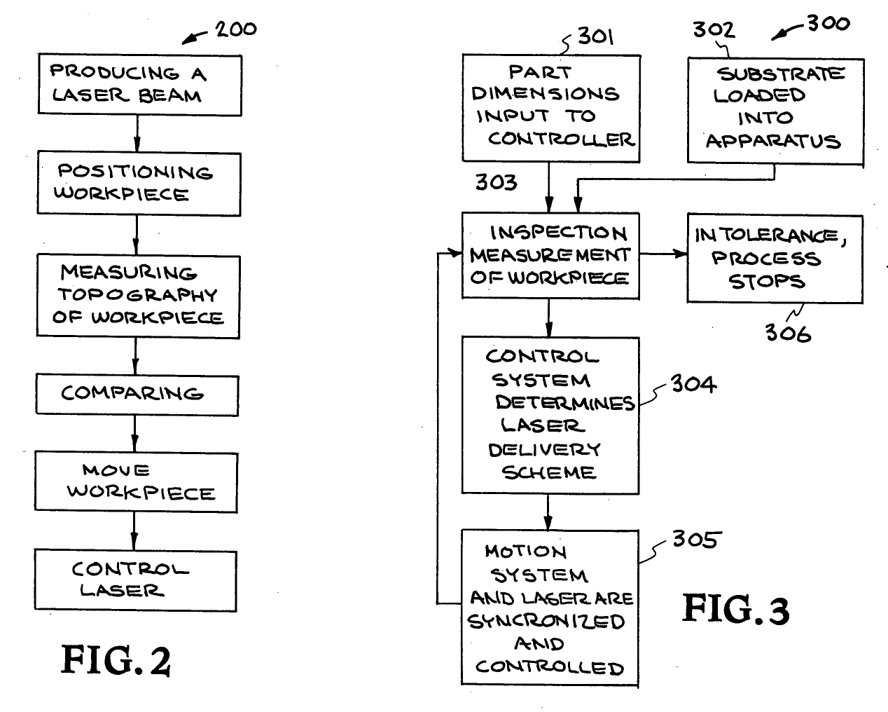

Referring again to the drawings, and in particular to FIG. 2, another embodiment of machining system constructed in accordance with the present invention is illustrated. The machining system is designated generally by the reference numeral 200. FIG. 2 is a flow chart that illustrates a method of machining a workpiece to desired finished workpiece specifications. The machining method 200 comprises the steps of using a laser to produce a laser beam; positioning the workpiece relative to the laser beam; using a profilometer to measure the topography of the workpiece and produce workpiece topography data; comparing the workpiece topography data with the desired finished workpiece specifications producing comparison data, controlling the positioning of the workpiece relative to the laser beam using the comparison data to cause the work piece to be moved with respect to the laser beam in a desirable fashion, within certain velocity, acceleration, and distance constraints, and controlling the laser using the comparison data to cause the laser beam to machine the workpiece to the desired finished workpiece specifications.

The present invention was reduced to practice, and the results were nominally within the limiting precision of the laser profilometer that was used. Arbitrarily truncated spherical surfaces (both concave and convex) were machined into a >99.5% dense high purity alumina sample. The control system was seen to have a very direct effect on the machining quality, as opposed to just a binary 100% or 0% control effort on each sector, difficult or rough areas received more control effort on each machining cycle. Multiple machining cycles were necessary to create the deep profiles.

The prototype laser mill is then composed of five principle components: a Ti:Sapphire femtosecond pulsed laser, laser profilometer sensing head, motion control system, data processing, and active power control. For taking surface data, the laser profilometer sensor head monitors the target, which is rastered under it. This is accomplished by running the stages through a LabVIEW interface, the latter of which then collects data from the head and sorts it into manageable data structures.

The laser system is an 825-nm Ti:Sapphire laser that operates at 1 kHz with pulses that have up to 2 mJ per pulse and has a controllable pulse width of 120 fs to 20 ps. The spatial mode of the beam is better than 90% Gaussian. The beam is focused using a 30-cm focal length spherical plano-convex lens. The workpiece is held on a 3-axis linear motion system that is driven by stepper motors to a positioning accuracy of 0.1 μm. The stages were run by a Newport MM4000 motion controller. A PC running LabVIEW is used to automate the data collection and laser controls for machining, as well as to issue commands to the MM4000 to coordinate motion, surface measurement, and machining. A Keyence LM-061 optical profilometer was used to generate a topographical map of the area to be machined, and this measurement was brought into the PC using an analog-to-digital multifunction acquisition card with 16-bits of accuracy to read the output voltage of the detector. This signal is proportional to the distance measurement. With proper averaging, surface measurement precision is 1 μm.

This device had 2 modes of operations, measurement and material removal. These modes alternated, whereby the surface was measured using the Keyence detector to map the topographical surface of the part, which was then compared to the desired shape, and algorithms were then used to determine what areas were higher than desired and how many laser pulses must be delivered to each location to achieve the desired surface structure. This data was then stored into data structures that could be fed to the laser control hardware.

The hardware used for laser power control consists of a National Instruments arbitrary waveform generator card, connected to a digital AND gate. This gate takes the 1000 Hz signal which runs the pockels cell slicer that is used to remove regenerative amplifier round-trip leakage to improve laser pulse contrast, and ANDs it to the control signal via the digital logic. When the logic is high, pulses are allowed to be delivered to the target, when it is low, they are dumped into a beam dump.

The alumina samples used are 1.26 inch disks of AmAlOx 87., acquired from Astro Met, Inc. This is high purity (99.95%) alumina with bulk density of 3.97 g/cm³ and is sintered from a grain size of 2 mm. These were machined under argon purge gas.

The method employed in the prototype simply gates the laser pulses, such that some fraction of the laser energy is delivered by blocking a proportion of the pulses from reaching the target. This can be done very quickly and accurately, as an optical gate with specialized fast response. The power control system produces kind of a gray-scale map, with each “shade” corresponding to a different numerical fraction of pulses. Typically, 8 shades (or 3 bits) were used in the prototype, but smoothing between data points and executing multiple passes provide a better surface quality than this implies.

An arbitrary waveform generator puts out the digital control signal that runs the optical gate. The card has a large onboard memory onto which one whole raster (machining cycle) can be loaded after the data has been processed. On each pass in the raster scan, the waveform is synchronized to the motion of the stages, and is played in real-time as the laser traverses the material. The computer receives a signal from the stages that a pass has begun, and then the control signal runs open loop in real-time until the pass is complete. The controller then waits until the beginning of the next pass. After this the entire measurement/machining cycle is repeated until the surface is within some specified tolerance of the input datum.

The system logs surface data in an open loop configuration similar to that employed for machining. The motion controller moves the stages at a constant velocity as the sensor heads take data at a predetermined rate corresponding to a desired resolution. However, small inconsistencies in the synchronization of the process often result in small variations in the number of data points taken in a single pass. To correct this, averaging fills in the missing data, and excessive extra data is ignored. Finally, the sensor head must be calibrated for each material to be machined.

The prototype met most expectations of operation and feasibility, such as:

Precise surface machining, profiles to within 1 μm roughness in nominal areas.

Complex three-dimensional profiles machined to within 5 um of an arbitrary datum.

Machined surface shows comparable or improved quality to that of a precision ground part, with no heat affected zone.

Referring again to the drawings, and in particular to FIGS. 3-6, additional embodiments of feedback controlled laser machining systems constructed in accordance with the present invention are illustrated. The systems are designed for precision machining of materials to micron-to-submicron tolerances.

Referring to FIG. 3, a flow chart illustrates a method of machining a workpiece to desired finished workpiece specifications. The system is designated generally by the reference numeral 300. The machining method 300 comprises the steps of using a laser to produce a laser beam; positioning the workpiece relative to the laser beam; using a profilometer to measure the topography of the workpiece and produce workpiece topography data; comparing the workpiece topography data with the desired finished workpiece specifications producing comparison data, controlling the positioning of the workpiece relative to the laser beam using the comparison data to cause the work piece to be moved with respect to the laser beam in a desirable fashion, within certain velocity, acceleration, and distance constraints, and controlling the laser using the comparison data to cause the laser beam to machine the workpiece to the desired finished workpiece specifications.

The process starts with step 301 wherein a workpiece design is placed into a computer or other process control electronics. In step 302 the workpiece or substrate is put into the system. In step 303 the workpiece or substrate is scanned using optical profilometry or interferometry. In step 304 the control system determines the laser delivery scheme. In step 304 the motion system and laser are synchronized and controlled to machine the workpiece to the desired finished workpiece specifications.

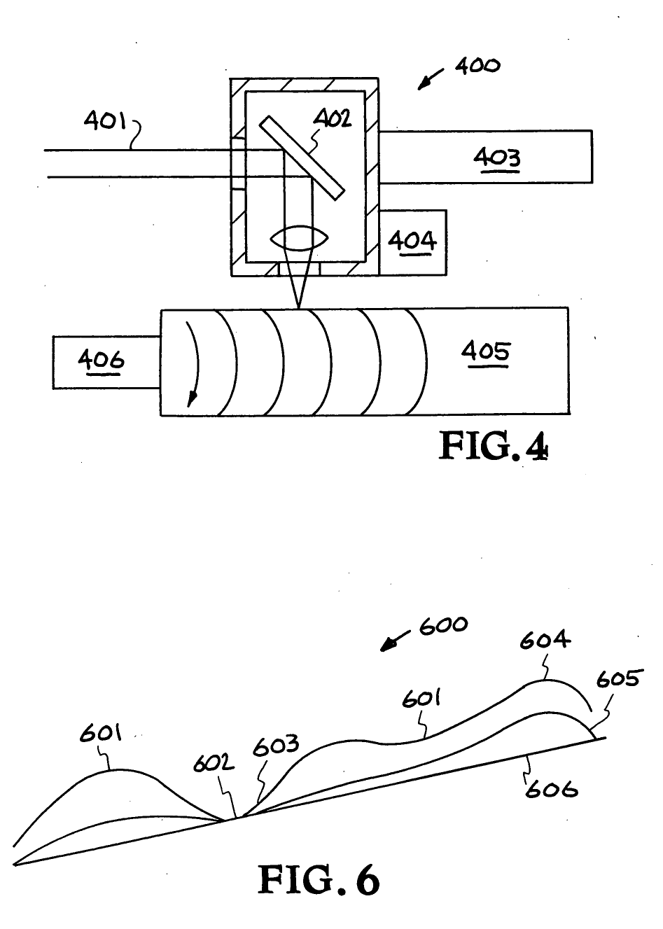

Referring to FIG. 4, another embodiment of machining system constructed in accordance with the present invention is illustrated. The machining system is designated generally by the reference numeral 400. The machining system 400 process a workpiece to desired finished workpiece specifications. The machining system 400 comprises a laser that produces a laser beam 401; a controlled stage 406 operatively connected to the laser that positions a workpiece 405 relative to the laser beam; a profilometer 404 that measures the topography of the work piece 405 and produces workpiece topography data; and a computer and control system operatively connected to the laser, to the controlled stage, and to the profilometer. The computer and control system compares the workpiece topography data with the desired finished workpiece specifications and controls the multi-axis motorized controlled stage and the laser. The computer and control system causes the work piece to be moved with respect to the laser beam in a desirable fashion, within certain velocity, acceleration, and distance constraints and controls the laser output so as to machine the workpiece to the desired finished workpiece specifications.

The laser machining machine system 400 uses the laser beam 401 for machining the workpiece 405. The laser machining system 400 includes a laser that produces the laser beam 401. The workpiece is positioned in the path of the laser beam by controlled stage 406 that provides movement of the workpiece 405. The laser profilometer 404 is positioned adjacent the laser. The laser profilometer utilizes a laser beam to measures the topography of a workpiece. Instead of a laser profilometer, an interferometric profilometer can be used as the profilometer. Instead of an interferometric profilometer, a white light interferometric profilometer can be used as the profilometer.

Once the laser profilometer measures the topography of the workpiece the topography data is provided to a computer and control system. The computer and control system compares the topography data of the workpiece with desired specifications of the workpiece that have been provided to the computer and control system. The desired specifications of the workpiece are prepared from specifications and/or drawings of the desired finished work piece. The computer and control system causes the workpiece to be moved with respect to the laser beam in a desirable fashion, within certain velocity, acceleration, and distance constraints. The computer and control system controls the laser and workpiece to machine the workpiece to the desired finished specifications.

Referring now to FIG. 5, an example of a sensing and cutting pattern 502 for workpiece 501 is illustrated. The pattern is designated generally by the reference numeral 500.

Referring now to FIG. 6, the operation of the laser machining machine system is illustrated. The system is designated generally by the reference numeral 600. The system 600 provides a system of machining a workpiece to desired finished workpiece specifications. A laser to produces a laser beam 601. The workpiece is positioned relative to the laser beam. A profilometer measures the topography of the workpiece and produces workpiece topography data. The desired surface 606 is produced by comparing the workpiece topography data with the desired finished workpiece specifications producing comparison data. A “ino pulses delivered section” 602 and a “gray-scale area” 603 are illustrated in FIG. 6. By controlling the positioning of the workpiece relative to the laser beam using the comparison data to cause the work piece to be moved with respect to the laser beam in a desirable fashion, within certain velocity, acceleration, and distance constraints, and controlling the laser using the comparison data to cause said laser beam to machine the workpiece to the desired finished workpiece specifications.

FIGS. 3-6 illustrate additional embodiments of feedback controlled laser machining systems constructed in accordance with the present invention. The systems are designed for precision machining of materials to micron-to-submicron tolerances.

In a specific example of the first experimental implementation of this invention, an optical profilometer was used. The workpiece is put into the apparatus and it is scanned, and deviations from the desired surface are compared with the model in the computer/electronic control system, and a program is then made to deliver laser pulses to the proper locations on the part.

This motion is usually something simple like a constant velocity raster scan of the surface of the material, or in the case of a spinning part, motion such as a helix down the rotation axis similar to that of a lathe is used. This can be implemented by placing the part on a moving stage or by scanning the beam and measuring hardware over the surface as needed. It may also be a slightly more complex motion that would more efficiently cover the area to be machined, and this may be input by the operator or determined by the computer.

An algorithm is then used to decide how many pulses are to be delivered to each area of the part. If the part is very far above the tolerance (lots of material needs to be removed), then every pulse the laser emits is delivered to the part. If the part is within desired tolerances in an area, then no pulses are delivered. If the part is close to tolerance, then the computer delivers a specific fraction of pulses determined by a precise approximation of how much material the laser will remove.

In the specific example the optical gate was an electro-optic modulator, or Pockels cell that is used in the laser system. Acousto-optical or fast mechanical devices could also serve the same purpose. After a machining pass is completed, then the system re-scans the part. If the part is within tolerances, then the process is stopped, otherwise more scanning and machining cycles are used.

In the specific example, there was an AND gate that took output from the control computer, which is delivered using an arbitrary waveform generator or other similar device, and was synchronized with the motion of the stages. The AND circuitry mixed it with the control electronics signal from the laser, which caused the optical gate to open at the time best tuned to let the pulse through for the laser for best high-power laser operation, and this was used to deliver the proper number of pulses to the proper location on the part.

This system used ultrashort pulses (10's of picoseconds to 10's of femtoseconds) to remove material. These laser pulses have been shown to remove as little as a few nanometers of material per pulse while leaving a clean, smooth surface. To focus on the “in-between” regions, grey-scale bit patterns are used in a binary fashion to deliver pulses, in areas that are “black” every pulse is set to 0 and no laser energy is delivered, this is used where the surface is at tolerance. In areas that are “white” every bit is set to 1, and all pulses are delivered. In areas that are near tolerance, that the laser may remove the material in a single pass, then an algorithm is used to select the appropriate “grey” word bit to remove just the right amount of material. This is selected on the basis of the amount of material to be removed and the know overlap of the laser pulses both in the direction of the scan, and in the overlap of the pulses on adjacent passes such that the aggregate of the passes removes the proper amount of material without going beyond what is necessary.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An apparatus for machining a workpiece to desired finished workpiece specifications, comprising:
a laser that produces a laser beam;
a controlled stage that positions the workpiece relative to said laser beam, wherein the workpiece is operatively connected to said controlled stage;
a profilometer that measures the topography of the work piece and produces workpiece topography data; and
a computer and control system operatively connected to said laser, to said controlled stage, and to said profilometer, wherein said computer and control system compares said workpiece topography data with the desired finished workpiece specifications and controls said controlled stage and said laser; wherein said computer and control system causes the workpiece to be moved with respect to the laser beam in a desired fashion, within certain velocity, acceleration, and distance constraints and wherein said computer and control system causes the laser to machine the workpiece to the desired finished workpiece specifications.

2. The apparatus for machining a workpiece to desired finished workpiece specifications of claim 1 wherein said profilometer is a laser profilometer.

3. The apparatus for machining a workpiece to desired finished workpiece specifications of claim 1 wherein said profilometer is a laser profilometer positioned adjacent said laser, said laser profilometer produces a profilometer laser beam that measures the topography of the work piece and produces workpiece topography data.

4. The apparatus for machining a workpiece to desired finished workpiece specifications of claim 1 wherein said profilometer is an interferometric profilometer.

5. The apparatus for machining a workpiece to desired finished workpiece specifications of claim 1 wherein said profilometer is a white light interferometric profilometer.

6. The apparatus for machining a workpiece to desired finished workpiece specifications of claim 1 wherein said laser is an ultrashort pulse laser.

7. The apparatus for machining a workpiece to desired finished workpiece specifications of claim 1 wherein said laser is a 825-nm Ti:Sapphire femtosecond pulsed laser.

8. An apparatus for machining a workpiece to desired finished workpiece specifications, comprising:
means for producing a laser beam;
means for positioning the workpiece relative to said laser beam;
means for measuring the topography of the work piece and producing workpiece topography data; and
computer and control means operatively connected to said means for producing a laser beam, to said means for positioning the workpiece relative to said laser beam, and to said means for measuring the topography of the work piece and producing workpiece topography data;
wherein said computer and control means compares said workpiece topography data with the desired finished workpiece specifications and controls said means for positioning the workpiece relative to said laser beam so that the workpiece is moved with respect to said laser beam in a desirable fashion, within certain velocity, acceleration, and distance constraints and wherein said computer and control means controls said means for producing a laser beam so that said laser beam machines the workpiece to the desired finished workpiece specifications.

9. The apparatus for machining a workpiece to desired finished workpiece specifications of claim 8 wherein said means for measuring the topography of the work piece and producing workpiece topography data is a laser profilometer.

10. The apparatus for machining a workpiece to desired finished workpiece specifications of claim 8 wherein said means for measuring the topography of the work piece and producing workpiece topography data is a laser profilometer positioned adjacent said laser, said laser profilometer produces a profilometer laser beam that measures the topography of the work piece and produces workpiece topography data.

11. The apparatus for machining a workpiece to desired finished workpiece specifications of claim 8 wherein said means for measuring the topography of the work piece and producing workpiece topography data is an interferometric profilometer.

12. The apparatus for machining a workpiece to desired finished workpiece specifications of claim 8 wherein said profilometer is a white light interferometric profilometer.

13. The apparatus for machining a workpiece to desired finished workpiece specifications of claim 8 wherein said means for producing a laser beam is an ultrashort pulse laser.

14. The apparatus for machining a workpiece to desired finished workpiece specifications of claim 8 wherein said means for producing a laser beam is a 825-nm Ti:Sapphire femtosecond pulsed laser.

15. A method of machining a workpiece to desired finished workpiece specifications, comprising the steps of:
using a laser to produce a laser beam;
positioning the workpiece relative to said laser beam;
using a profilometer to measure the topography of the workpiece and
produce workpiece topography data;
comparing said workpiece topography data with the desired finished workpiece specifications producing comparison data,
controlling said positioning of the workpiece relative to said laser beam using said comparison data to cause the work piece to be moved with respect to said laser beam in a desirable fashion, within certain velocity, acceleration, and distance constraints, and
controlling said laser using said comparison data to cause said laser beam to machine the workpiece to the desired finished workpiece specifications.

16. The method of machining a workpiece to desired finished workpiece specifications of claim 13 wherein said step of using a laser to produce a laser beam comprises using a laser to produce a laser beam of 1 kHz with pulses that have up to 2 mJ per pulse and has a controllable pulse width of 120 fs to 20 ps.
